(19) United States
(12) Patent Application Publication
(10) Pub. No.: US 2025/0055606 A1
(43) Pub. Date: Feb. 13, 2025

(54) DYNAMIC COEXISTENCE OF PHYSICAL SIDELINK FEEDBACK CHANNEL TRANSMISSIONS AND SIDELINK REFERENCE SIGNAL TRANSMISSIONS

(71) Applicant: Nokia Technologies Oy, Espoo (FI)

(72) Inventor: Daniel MEDINA, München (DE)

(21) Appl. No.: 18/786,904

(22) Filed: Jul. 29, 2024

(30) Foreign Application Priority Data
Aug. 8, 2023 (FI) 20235875

(51) Int. Cl. H04L 1/1829; H04L 5/00; H04W 72/40

(52) U.S. Cl. CPC H04L 1/1861; H04L 5/0048; H04W 72/40

(57) ABSTRACT

A method for dynamic coexistence of physical sidelink feedback channel (PSFCH) transmissions and standalone sidelink reference signal (RS) transmissions including at a first apparatus, determine a candidate resource set for transmission of a first RS, the candidate resource set including a plurality of candidate resources, wherein each of the plurality of candidate resources occurs within a PSFCH transmission occasion; receive sidelink control information (SCI) from at least one second apparatus indicating a reserved resource for transmission of data by the at least one second apparatus; determine, based at least on the reserved resource, at least one associated PSFCH resource for transmission of feedback to the at least one second apparatus; and determine whether to exclude at least one candidate resource from the candidate resource set based on whether the at least one candidate resource overlaps, at least partially, with the at least one associated PSFCH resource.

### FIELDS

Various example embodiments of the present disclosure generally relate to the field of telecommunication and in particular, to methods, devices, apparatuses and computer readable storage media for dynamic coexistence of physical sidelink (SL) feedback channel (PSFCH) transmissions and SL reference signal (RS) transmissions, especially for channel state information RS (CSI-RS) for beam management in frequency range 2 (FR2).

### BACKGROUND

An ongoing 3GPP work item on new radio (NR) SL evolution addresses the objective related to SL operation in FR2 licensed spectrum. This study includes the support of SL beam management (including initial beam-pairing, beam maintenance, and beam failure recovery, etc.) by reusing existing SL CSI framework and reusing Uu beam management concepts wherever possible.

### SUMMARY

In a first aspect of the present disclosure, there is provided a first apparatus. The first apparatus comprises at least one processor; and at least one memory storing instructions that, when executed by the at least one processor, cause the first apparatus at least to: determine a candidate resource set for transmission of a first RS, the candidate resource set comprising a plurality of candidate resources, wherein each of the plurality of candidate resources occurs within a PSFCH transmission occasion; receive SCI from at least one second apparatus indicating a reserved resource for transmission of data by the at least one second apparatus; determine, based at least on the reserved resource, at least one associated PSFCH resource for transmission of feedback to the at least one second apparatus; and determine whether to exclude at least one candidate resource from the candidate resource set based at least on whether the at least one candidate resource overlaps, at least partially, with the at least one associated PSFCH resource.

In a second aspect of the present disclosure, there is provided a method. The method comprises: determining a candidate resource set for transmission of a first RS, the candidate resource set comprising a plurality of candidate resources, wherein each of the plurality of candidate resources occurs within a PSFCH transmission occasion; receiving SCI from at least one second apparatus indicating a reserved resource for transmission of data by the at least one second apparatus; determining, based at least on the reserved resource, at least one associated PSFCH resource for transmission of feedback to the at least one second apparatus; and determining whether to exclude at least one candidate resource from the candidate resource set based at least on whether the at least one candidate resource overlaps, at least partially, with the at least one associated PSFCH resource.

In a third aspect of the present disclosure, there is provided a first apparatus. The first apparatus comprises means for determining a candidate resource set for transmission of a first RS, the candidate resource set comprising a plurality of candidate resources, wherein each of the plurality of candidate resources occurs within a PSFCH transmission occasion; means for receiving SCI from at least one second apparatus indicating a reserved resource for transmission of data by the at least one second apparatus; means for determining, based at least on the reserved resource, at least one associated PSFCH resource for transmission of feedback to the at least one second apparatus; and means for determining whether to exclude at least one candidate resource from the candidate resource set based at least on whether the at least one candidate resource overlaps, at least partially, with the at least one associated PSFCH resource.

In a fourth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart illustrating an example of process according to some example embodiments of the present disclosure;

FIG. 3 illustrates an example of resource allocation according to some example embodiments of the present disclosure;

FIG. 4 illustrates a flowchart of a method implemented at a first apparatus according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

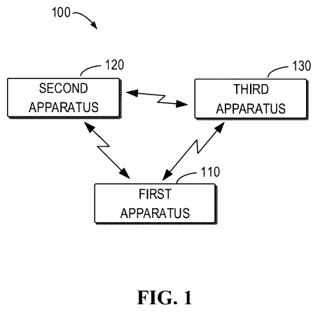

FIG. 1 illustrates an example communication environment 100 in which example embodiments of the present disclosure can be implemented. In the communication environment 100 may comprise a first apparatus 110, a second apparatus 120 and a third apparatus 130. The first apparatus 110, the second apparatus 120 and the third apparatus 130 may communicate with each other.

In the following, for the purpose of illustration, some example embodiments are described with the first apparatus 110, the second apparatus 120 and the third apparatus 130 each operating as a terminal device or a UE. However, in some example embodiments, operations described in connection with a terminal device may be implemented at a network device or other device.

In some scenarios, the communication between each two of the first apparatus 110, the second apparatus 120 and the third apparatus 130 in the communication network 100 may referred to as a sidelink communication. In the sidelink communication, the communication between terminal devices (for example, V2V, V2P, V2I communications) can be performed via sidelinks. For the sidelink communication, information may be transmitted from a TX terminal device to one or more RX terminal devices in a broadcast, or groupcast, or unicast manner.

It is to be understood that the number of apparatuses shown in FIG. 1 is given for the purpose of illustration without suggesting any limitations. The communication environment 100 may include any suitable number of apparatuses.

In some scenarios, a network device (e.g., a gNB) (not shown) may be responsible for the resource allocation of the sidelink transmission, which may be called as the resource allocation mode 1. For example, the network device may provide grants of sidelink resources to the first apparatus 110 for the sidelink communication between the first apparatus 110 and the second apparatus 120 in the resource allocation mode 1.

In some other scenarios, each of the first apparatus 110, the second apparatus 120 and the third apparatus 130 may autonomously select transmission resources for the sidelink communication, which may be called as the resource allocation mode 2. For example, if the first apparatus 110 autonomously select transmission resources for the sidelink communication between the first apparatus 110 and the second apparatus 120, the first apparatus 110 may perform a sensing procedure over the configured sidelink transmission resource pool(s), to obtain the knowledge of the reserved resource(s) by other nearby sidelink UE(s). Based on the knowledge obtained from resource sensing, the first apparatus 110 may select resource(s) from the available sidelink resources, accordingly.

The sidelink control information (SCI) may be decoded for the first apparatus 110 to perform sensing and obtain the necessary information associated with the sidelink transmission. The SCI associated with data transmission may include a 1^{st}-stage SCI and a 2^{nd}-stage SCI. For example, the 1^{st}-stage SCI may be carried by Physical Sidelink Control Channel (PSCCH) and comprise information to enable sensing operations and information needed to determine resource allocation of the Physical Sidelink Shared Channel (PSSCH) and to decode 2nd-stage SCI.

The 2^{nd}-stage SCI may be carried by PSSCH, which may be multiplexed with sidelink shared channel (sidelink-SCH) and comprise source and destination identities for the sidelink transmission, information to identify and decode the associated sidelink-SCH Transport Block (TB), control of Hybrid Automatic Repeat Request (HARQ) feedback in unicast/groupcast, and a trigger for CSI feedback in unicast.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the study of sidelink operation in FR2 licensed spectrum, standalone sidelink CSI-RS transmissions has been considered. The study may comprise the physical layer structure and resources, resource allocation and resource indication.

The resource allocation for SL CSI-RS, especially for the standalone SL CSI-RS is an open question.

Physical Sidelink Feedback Channel (PSFCH) transmission occasions (e.g., configured for transmission of SL HARQ feedback or resource conflict indications) provide a natural choice for transmitting standalone SL CSI-RS, as their strict time-orthogonality with respect to PSCCH/PSSCH resources ensures a harmonious coexistence between PSCCH/PSSCH and standalone SL CSI-RS (i.e., no collisions between SL data transmissions and SL CSI-RS transmissions). However, if SL CSI-RS are transmitted during PSFCH transmission occasions, interference to/from transmissions of SL HARQ feedback or resource conflict indications needs to be avoided as much as possible.

Therefore, a mechanism for dynamically multiplexing standalone SL CSI-RS transmissions and PSFCH transmissions may be considered.

According to some example embodiments of the present disclosure, there is provided a solution for dynamic coexistence of PSFCH transmissions and standalone SL reference signal (RS) transmissions, especially for SL beam management in FR2. In this solution, the first apparatus 110 determines a candidate resource set for transmission of a first RS. The candidate resource set comprises a plurality of candidate resources and each of the plurality of candidate resources occurs within a PSFCH transmission occasion. The first apparatus 110 further receives SCI from at least one second apparatus 120 indicating a reserved resource for transmission of data by the at least one second apparatus 120 and determines, based at least on the reserved resource, at least one associated PSFCH resource for transmission of feedback to the at least one second apparatus 120. The first apparatus 110 determines whether to exclude at least one candidate resource from the candidate resource set based at least on whether the at least one candidate resource overlaps, at least partially, with the at least one associated PSFCH resource.

Example embodiments of the present disclosure will be described in detail below with reference to the accompanying drawings.

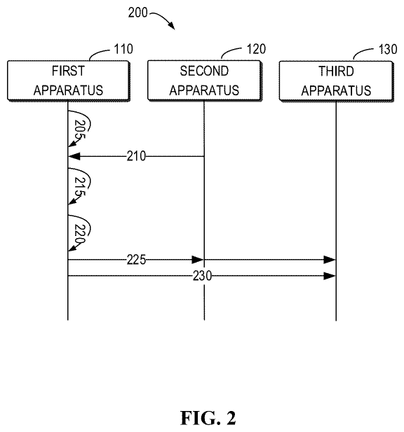

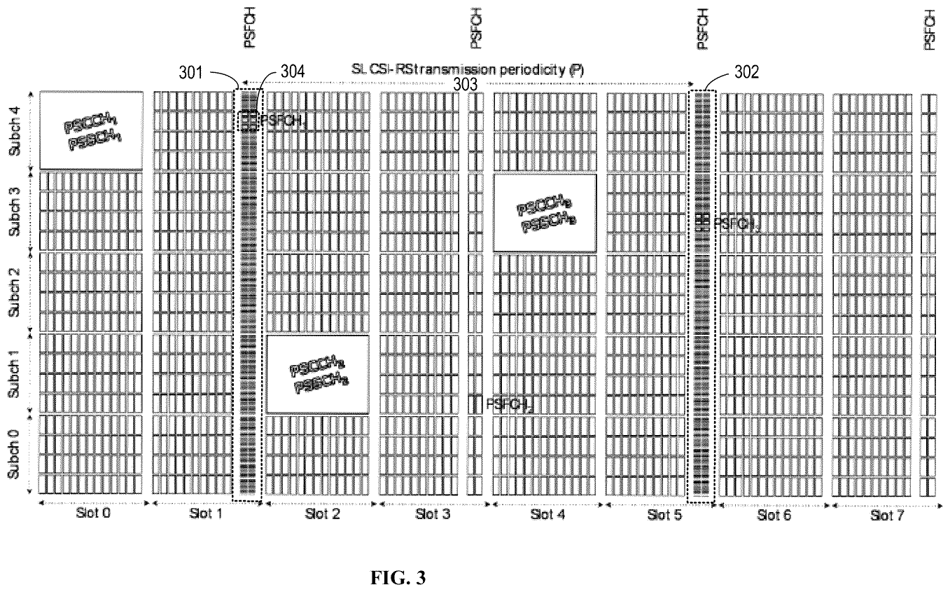

Reference is now made to FIG. 2, which shows a signaling chart 200 for communication according to some example embodiments of the present disclosure. As shown in FIG. 2, the signaling chart 200 involves the first apparatus 110 and the second apparatus 120. FIG. 3 illustrates an example of resource allocation according to some example embodiments of the present disclosure. For the purpose of discussion, reference is made to FIG. 3 to describe the signaling chart 200. It would be appreciated that, in some scenarios, the second apparatus 120, the third apparatus 130 and/or other terminal devices may perform similar operations as described with respect to the first apparatus 110 below.

As shown in FIG. 2, the first apparatus 110 may determine (205) a candidate resource set (S_{A}) for a transmission of a SL CSI-RS (hereinafter referred to as the first RS) comprising a plurality of candidate SL CSI-RS resources (c₁, . . . , cₙ). For example, a candidate SL CSI-RS resource may be defined as a comb structure in the frequency domain (similar to that specified for sounding reference signals (SRS)) comprising a plurality of equally spaced resource elements (REs) associated with a PSFCH symbol or PSFCH transmission occasion (e.g., PSFCH transmission occasion 301 in slot 1 or PSFCH transmission occasion 302 in slot 5 as shown in FIG. 3).

Different candidate SL CSI-RS resources (c₁, . . . , cₙ) may be determined within a given SL CSI-RS resource selection window (RSW) and resource pool (RP). For example, for a RSW comprising L PSFCH transmission occasions (s₁, . . . , s_{L}) and a transmission comb density N (commonly referred to as a comb-N structure), a total of L×N orthogonal SL CSI-RS resources may be determined as initial candidate SL CSI-RS resources (c₁, . . . , cₙ) for SL CSI-RS transmission by the first apparatus 110.

The first apparatus 110 may further receive (210) SCI from the second apparatus 120. The SCI may indicate a reserved resource for transmission of data by the second apparatus 120.

For example, the first apparatus 110 may perform sensing of the radio channel continuously, including SCI decoding and associated RSRP measurement. Such sensing allows the first apparatus 110 to become aware of future PSCCH/PSSCH resources reserved for transmission by nearby UEs (e.g., the second apparatus 120). For example, the first apparatus 110 may have received a PSCCH/PSSCH transmission from the second apparatus 120 indicating a radio resource (r₁) reserved for transmission by the second apparatus 120.

Then the first apparatus 110 may determine (215) at least one associated PSFCH resource for transmission of feedback to the second apparatus 120.

For example, based on the indicated reserved radio resource (r₁), an associated PSFCH resource (f₁) (e.g., an associated PSFCH resource 304 as shown in FIG. 3) for transmission of SL HARQ feedback to the second apparatus 120 may be determined. This is made possible thanks to the implicit PSSCH-to-PSFCH resource mapping. In case of SL groupcast with both positive acknowledgement (ACK) and negative acknowledgement (NACK) feedback, there may be multiple associated PSFCH resources for transmission of feedback by different group members.

Based on the determined at least one associated PSFCH resource, the first apparatus 110 may determine (220) whether to exclude a candidate resource from the candidate resource set based at least on whether the candidate resource overlaps, at least partially, with the at least one associated PSFCH resource. That is, the excluded candidate resource may not be used for transmitting the first RS.

The first apparatus 110 may determine whether to exclude a candidate SL CSI-RS resource from the candidate resource set (S_{A}) at least based on whether the candidate SL CSI-RS resource, or a future occurrence thereof in accordance with a given SL CSI-RS transmission periodicity (P) (e.g., a SL CSI-RS transmission periodicity 303 as shown in FIG. 3), overlaps with the determined associated PSFCH resource (f₁). If there is no overlap, the candidate SL CSI-RS resource may remain in the candidate resource set (S_{A}).

On the other hand, if the overlap is non-zero, other criteria may be considered

as well.

As an example, the first apparatus 110 may determine whether to exclude the candidate resource further based on a reference signal receiver power (RSRP) associated with the received SCI or received PSCCH/PSSCH transmission.

For example, if the RSRP is high, the second apparatus 120 (i.e., the PSFCH receiver) may be very close, thus the impact of transmitting SL CSI-RS on the PSFCH reception quality will be stronger. Conversely, if the RSRP is low, the second apparatus 120 may be far enough that PSFCH reception may not be adversely impacted.

As another example, the first apparatus 110 may determine whether to exclude the candidate resource further based on a priority associated with the received SCI. For example, even if the RSRP is low, a PSFCH reception corresponding to a top-priority PSCCH/PSSCH transmission may need to be protected as much as possible. This may be achieved by using a priority dependent RSRP threshold for resource exclusion.

As still another example, the first apparatus 110 may determine whether to exclude the candidate resource further based on a number of resource elements (REs) or subcarriers of the candidate resource overlapping with the at least one associated PSFCH resource. For example, if a sparse transmission comb is used, such as comb-12, there may be a single RE overlapping, and the interference may be tolerable. Conversely, if a dense transmission comb is used, such as comb-1 (i.e., all REs), there may be 12 REs overlapping for each determined associated PSFCH resource, with a consequently higher interference potential.

An RSRP threshold for resource exclusion may be used that is a function of the number of overlapping REs. For example, a higher RSRP threshold may be used when the fraction of overlapping REs (e.g., 1/12) is small and a lower RSRP threshold may be used when the fraction of overlapping REs (e.g., 12/12) is large.

In some embodiments, a candidate SL CSI-RS resource may be defined at least by a code domain allocation (e.g., a cyclic shift of a sequence) to be used for SL CSI-RS transmission. In such embodiments, the first apparatus 110 may determine whether to exclude a candidate SL CSI-RS resource from the candidate resource set (S_{A}) based on the code domain allocation of the candidate SL CSI-RS resource. In such embodiments, the first apparatus 110 may determine whether to exclude a candidate SL CSI-RS resource from the candidate resource set (S_{A}) based on a code domain allocation (e.g., cyclic shift) of the determined associated PSFCH resource (f₁).

Different code domain allocations (of the SL CSI-RS sequence and the PSFCH sequence) may lead to different interference potential between SL CSI-RS and PSFCH transmissions. An RSRP threshold for resource exclusion may be used that is a function of the code domain allocations. For example, a higher RSRP threshold may be used when the code domain allocations are such that the interference potential is low and a lower RSRP threshold may be used when the code domain allocations are such that the interference potential is high.

Furthermore, a number of overlapping PSFCH resources expected to be used for feedback transmission may be used for determining whether to exclude the candidate resource. If the candidate SL CSI-RS resource overlaps with a large number of PSFCH resources that are expected to be used, e.g., for SL HARQ feedback transmission, the system-level impact may be more significant (e.g., many HARQ retransmissions as a result of many PSFCH reception failures) than if the candidate SL CSI-RS resource overlaps with a small number thereof. Similarly, from the perspective of SL CSI-RS reception, a candidate SL CSI-RS resource overlapping with a large number of PSFCH resources expected to be used may suffer significant interference, while a candidate SL CSI-RS resource overlapping with a small number thereof may suffer a tolerable amount of interference.

After excluding one or more overlapping candidate SL CSI-RS resources, the first apparatus 110 may select at least one candidate SL CSI-RS resource remaining in the candidate resource set (S_{A}) and transmit a SL CSI-RS thereon.

Prior to SL CSI-RS transmission, the first apparatus 110 may transmit (225), e.g., to other UEs including but not limit to the second apparatus 120 and/or the third apparatus 130, control information (e.g., SCI) indicating the selected at least one candidate SL CSI-RS resource as reserved for SL CSI-RS transmission by the first apparatus 110. This allows other UEs which decode such control information to potentially avoid selecting an overlapping SL CSI-RS resource.

In some cases, the first apparatus 110 may not wish to transmit SL CSI-RS itself, but rather assist the third apparatus 130 in SL CSI-RS resource selection (so-called inter-UE coordination, IUC). The first apparatus 110 may transmit coordination information indicating at least one candidate SL CSI-RS resource remaining in the candidate resource set (S_{A}) after resource exclusion to the third apparatus 130 for SL CSI-RS transmission by the third apparatus 130.

Moreover, in some embodiments, the first apparatus 110 may determine a PSFCH resource occupancy metric, e.g., based on energy sensing during PSFCH symbols or a channel busy ratio (CBR). Furthermore, the first apparatus 110 may determine a PSFCH resource occupancy metric based on the determined associated PSFCH resources expected to be used for PSFCH transmissions and/or received SL CSI-RS resource reservation indications.

Such a metric may naturally capture PSFCH resource occupancy by SL HARQ feedback transmissions, resource conflict indications (IUC scheme 2) as well as other SL CSI-RS transmissions.

The first apparatus 110 may use such a metric for SL CSI-RS congestion control, e.g., by selecting a SL CSI-RS transmission comb density (N). For example, when the PSFCH resource occupancy (and/or the CBR) is high, the first apparatus 110 may select sparser transmission combs (e.g., comb-12) for determining the initial candidate resource set (S_{A})—this may result in a lower beam measurement quality than using denser transmission combs (e.g., comb-2) but may reduce the impact of SL CSI-RS transmissions on PSFCH performance.

Furthermore, the SL CSI-RS congestion control may also be achieved by the first apparatus by selecting a SL CSI-RS transmission periodicity (P) defining a distance in time between periodic resources associated with a candidate CSI-RS resource (c₁, . . . , cₙ).

For example, when the PSFCH resource occupancy (and/or the CBR) is high, the first apparatus 110 may select a longer SL CSI-RS transmission periodicity (P) (e.g., every 16 slots)—this may result in a lower beam measurement quality or staleness (e.g., due to UE mobility) than using shorter SL CSI-RS transmission periodicities (e.g., every 4 slots) but may reduce the impact of SL CSI-RS transmissions on PSFCH performance. Such SL CSI-RS transmission sparsification in the time and/or frequency domain may allow for a graceful degradation of beam measurement quality in a congested resource pool while ensuring a low impact on PSFCH transmission performance.

Finally, the first apparatus 110 may also select a SL CSI-RS transmission bandwidth based on the determined PSFCH resource occupancy. For example, when the PSFCH resource occupancy (and/or the CBR) is low, a wider transmission bandwidth may be used for SL CSI-RS transmission, e.g., allowing the SL CSI-RS transmission to occupy resource blocks (RBs) that are otherwise dedicated for PSFCH transmissions.

Based on the solution of the present disclosure, a collision between the SL CSI-RS transmission and PSFCH transmission may be avoided. RSRP associated with decoded SCI provides a means for estimating the impact of standalone SL CSI-RS transmission on PSFCH reception.

Furthermore, automatic gain control (AGC) issues caused by transmission of standalone SL CSI-RS in the middle of a slot are avoided. In addition, as both SL CSI-RS and PSFCH transmissions are sequence-based, the code domain (e.g., sequence cyclic shifts) may be exploited to further minimize cross-interference.

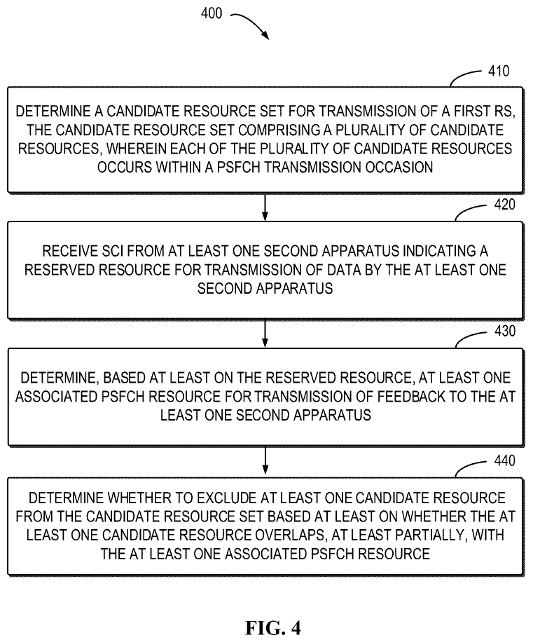

FIG. 4 shows a flowchart of an example method 400 implemented at a first apparatus in accordance with some example embodiments of the present disclosure. For the purpose of discussion, the method 400 will be described from the perspective of the first apparatus 110 in FIG. 1.

At block 410, the first apparatus 110 determines a candidate resource set for transmission of a first RS, the candidate resource set comprising a plurality of candidate resources, wherein each of the plurality of candidate resources occurs within a PSFCH transmission occasion.

At block 420, the first apparatus 110 receives SCI from at least one second apparatus indicating a reserved resource for transmission of data by the at least one second apparatus.

At block 430, the first apparatus 110 determines, based at least on the reserved resource, at least one associated PSFCH resource for transmission of feedback to the at least one second apparatus.

At block 440, the first apparatus 110 determines whether to exclude at least one candidate resource from the candidate resource set based at least on whether the at least one candidate resource overlaps, at least partially, with the at least one associated PSFCH resource.

In some example embodiments, the method 400 further comprises: selecting at least one remaining candidate resource in the candidate resource set after excluding the at least one candidate resource; and transmitting the first RS using the selected at least one remaining candidate resource.

In some example embodiments, the method 400 further comprises: determining whether to exclude the at least one candidate resource further based on a received signal strength (e.g., RSRP) associated with the received SCI.

In some example embodiments, the method 400 further comprises: determining whether to exclude the at least one candidate resource further based on a priority associated with the received sidelink control information, SCI.

In some example embodiments, the method 400 further comprises: determining whether to exclude the at least one candidate resource further based on a number of subcarriers of the at least one candidate resource overlapping with the at least one associated PSFCH resource.

In some example embodiments, the method 400 further comprises: in accordance with a determination that a received signal strength associated with the received SCI is higher than a threshold, determining to exclude the at least one candidate resource, wherein the threshold is a function of the number of overlapping subcarriers.

In some example embodiments, the method 400 further comprises: determining whether to exclude the at least one candidate resource further based on at least one of: the code domain allocation of the at least one candidate resource, or a code domain allocation of the at least one associated PSFCH resource.

In some example embodiments, the method 400 further comprises: in accordance with a determination that a received signal strength associated with the received SCI is higher than a threshold, determining to exclude the at least one candidate resource, wherein the threshold is a function of at least one of: the code domain allocation of the at least one candidate resource, or the code domain allocation of the at least one associated PSFCH resource.

In some example embodiments, the method 400 further comprises: determining whether to exclude the at least one candidate resource further based on a number of PSFCH resources, overlapping with the at least one candidate resource, expected to be used for transmission of feedback.

In some example embodiments, the method 400 further comprises: transmitting, to a third apparatus, coordination information indicating at least one remaining candidate resource in the candidate resource set after excluding the at least one candidate resource, for transmitting the first RS by the third apparatus.

In some example embodiments, the method 400 further comprises: determining a PSFCH resource occupancy based on at least one of: the determined at least one associated PSFCH resource expected to be used for transmission of feedback; at least one resource reservation indication associated with a second RS; or a channel busy ratio, CBR.

In some example embodiments, the method 400 further comprises: selecting a transmission comb density associated with the first RS based at least on the determined PSFCH resource occupancy and/or a CBR.

In some example embodiments, the method 400 further comprises: selecting a transmission periodicity associated with the first RS based at least on the determined PSFCH resource occupancy and/or a CBR.

In some example embodiments, the method 400 further comprises: determining a bandwidth for transmitting the first RS based at least on the determined PSFCH resource occupancy and/or a CBR.

In some example embodiments, a first apparatus capable of performing the method 400 (for example, the first apparatus 110 in FIG. 1) may comprise means for performing the respective operations of the method 400. The means may be implemented in any suitable form. For example, the means may be implemented in a circuitry or software module. The first apparatus may be implemented as or included in the first apparatus 110 in FIG. 1.

In some example embodiments, the first apparatus comprises means for determining a candidate resource set for transmission of a first RS, the candidate resource set comprising a plurality of candidate resources, wherein each of the plurality of candidate resources occurs within a PSFCH transmission occasion; means for receiving SCI from at least one second apparatus indicating a reserved resource for transmission of data by the at least one second apparatus; means for determining, based at least on the reserved resource, at least one associated PSFCH resource for transmission of feedback to the at least one second apparatus; and means for determining whether to exclude at least one candidate resource from the candidate resource set based at least on whether the at least one candidate resource overlaps, at least partially, with the at least one associated PSFCH resource.

In some example embodiments, the first apparatus further comprises: means for selecting at least one remaining candidate resource in the candidate resource set after excluding the at least one candidate resource; and means for transmitting the first RS using the selected at least one remaining candidate resource.

In some example embodiments, the first apparatus further comprises: means for determining whether to exclude the at least one candidate resource further based on a received signal strength associated with the received SCI.

In some example embodiments, the first apparatus further comprises: means for determining whether to exclude the at least one candidate resource further based on a priority associated with the received sidelink control information, SCI.

In some example embodiments, the first apparatus further comprises: means for determining whether to exclude the at least one candidate resource further based on a number of subcarriers of the at least one candidate resource overlapping with the at least one associated PSFCH resource.

In some example embodiments, the first apparatus further comprises: means for in accordance with a determination that a received signal strength associated with the received SCI is higher than a threshold, determining to exclude the at least one candidate resource, wherein the threshold is a function of the number of overlapping subcarriers.

In some example embodiments, the at least one candidate resource is defined at least by a code domain allocation to be used for transmitting the RS, wherein the first apparatus further comprises: means for determining whether to exclude the at least one candidate resource further based on at least one of: the code domain allocation of the at least one candidate resource, or a code domain allocation of the at least one associated PSFCH resource.

In some example embodiments, the first apparatus further comprises: means for in accordance with a determination that a received signal strength associated with the received SCI is higher than a threshold, determining to exclude the at least one candidate resource, wherein the threshold is a function of at least one of: the code domain allocation of the at least one candidate resource, or the code domain allocation of the at least one associated PSFCH resource.

In some example embodiments, the first apparatus further comprises: means for determining whether to exclude the at least one candidate resource further based on a number of PSFCH resources, overlapping with the at least one candidate resource, expected to be used for transmission of feedback.

In some example embodiments, the first apparatus further comprises: means for transmitting, to a third apparatus, coordination information indicating at least one remaining candidate resource in the candidate resource set after excluding the at least one candidate resource, for transmitting the first RS by the third apparatus.

In some example embodiments, the first apparatus further comprises: means for determining a PSFCH resource occupancy based on at least one of: the determined at least one associated PSFCH resource expected to be used for transmission of feedback; at least one resource reservation indication associated with a second RS; or a channel busy ratio, CBR.

In some example embodiments, the first apparatus further comprises: means for selecting a transmission comb density associated with the first RS based at least on the determined PSFCH resource occupancy and/or a CBR.

In some example embodiments, the first apparatus further comprises: means for selecting a transmission periodicity associated with the first RS based at least on the determined PSFCH resource occupancy and/or a CBR.

In some example embodiments, the first apparatus further comprises: means for determining a bandwidth for transmitting the first RS based at least on the determined PSFCH resource occupancy and/or a CBR.

In some example embodiments, the first apparatus further comprises means for performing other operations in some example embodiments of the method 400 or the first apparatus 110. In some example embodiments, the means comprises at least one processor; and at least one memory storing instructions that, when executed by the at least one processor, cause the performance of the first apparatus.

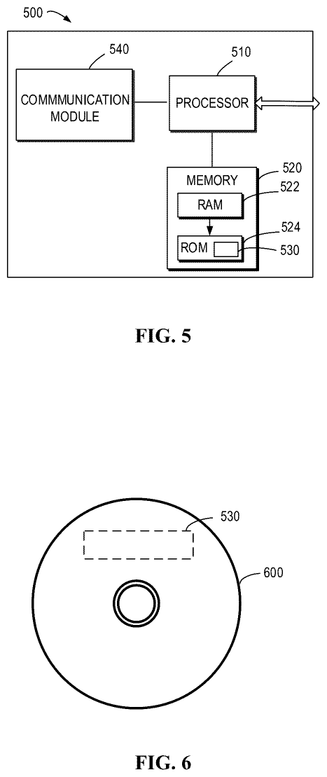

FIG. 5 is a simplified block diagram of a device 500 that is suitable for implementing example embodiments of the present disclosure. The device 500 may be provided to implement a communication device, for example, the first apparatus 110 or the second apparatus 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-15. (canceled)

16. A first apparatus comprising:
at least one processor; and
at least one memory storing instructions that, when executed by the at least one processor, cause the first apparatus at least to:
determine a candidate resource set for transmission of a first reference signal, RS, the candidate resource set comprising a plurality of candidate resources, wherein each of the plurality of candidate resources occurs within a physical sidelink feedback channel, PSFCH, transmission occasion;
receive sidelink control information, SCI, from at least one second apparatus indicating a reserved resource for transmission of data by the at least one second apparatus;
determine, based at least on the reserved resource, at least one associated PSFCH resource for transmission of feedback to the at least one second apparatus; and
determine whether to exclude at least one candidate resource from the candidate resource set based at least on whether the at least one candidate resource overlaps, at least partially, with the at least one associated PSFCH resource.

17. The first apparatus of claim 16, wherein the first apparatus is caused to:
select at least one remaining candidate resource in the candidate resource set after excluding the at least one candidate resource; and
transmit the first RS using the selected at least one remaining candidate resource.

18. The first apparatus of claim 16, wherein the first apparatus is caused to:
determine whether to exclude the at least one candidate resource further based on a received signal strength associated with the received SCI.

19. The first apparatus of claim 16, wherein the first apparatus is caused to:
determine whether to exclude the at least one candidate resource further based on a priority associated with the received SCI.

20. The first apparatus of claim 16, wherein the first apparatus is caused to:
determine whether to exclude the at least one candidate resource further based on a number of subcarriers of the at least one candidate resource overlapping with the at least one associated PSFCH resource.

21. The first apparatus of claim 20, wherein the first apparatus is caused to:
in accordance with a determination that a received signal strength associated with the received SCI is higher than a threshold, determine to exclude the at least one candidate resource, wherein the threshold is a function of the number of overlapping subcarriers.

22. The first apparatus of claim 16, wherein the at least one candidate resource is defined at least by a code domain allocation to be used for transmitting the first RS, wherein the first apparatus is caused to:
determine whether to exclude the at least one candidate resource further based on at least one of:
the code domain allocation of the at least one candidate resource, or
a code domain allocation of the at least one associated PSFCH resource.

23. The first apparatus of claim 22, wherein the first apparatus is caused to:
in accordance with a determination that a received signal strength associated with the received SCI is higher than a threshold, determine to exclude the at least one candidate resource, wherein the threshold is a function of at least one of:
the code domain allocation of the at least one candidate resource, or
the code domain allocation of the at least one associated PSFCH resource.

24. The first apparatus of claim 16, wherein the first apparatus is caused to:
determine whether to exclude the at least one candidate resource further based on a number of PSFCH resources, overlapping with the at least one candidate resource, expected to be used for transmission of feedback.

25. The first apparatus of claim 16, wherein the first apparatus is caused to:
transmit, to a third apparatus, coordination information indicating at least one remaining candidate resource in the candidate resource set after excluding the at least one candidate resource, for transmitting the first RS by the third apparatus.

26. The first apparatus of claim 16, wherein the first apparatus is caused to:
determine a PSFCH resource occupancy based on at least one of:
the determined at least one associated PSFCH resource expected to be used for transmission of feedback;
at least one resource reservation indication associated with a second RS; or
a channel busy ratio, CBR.

27. The first apparatus of claim 26, wherein the first apparatus is caused to:
select a transmission comb density associated with the first RS based at least on the determined PSFCH resource occupancy and/or the CBR.

28. The first apparatus of claim 26, wherein the first apparatus is caused to:
select a transmission periodicity associated with the first RS based at least on the determined PSFCH resource occupancy and/or the CBR.

29. The first apparatus of claim 26, wherein the first apparatus is caused to:
determine a bandwidth for transmitting the first RS based at least on the determined PSFCH resource occupancy and/or the CBR.

30. A method comprising:
determining a candidate resource set for transmission of a first reference signal, RS, the candidate resource set comprising a plurality of candidate resources, wherein each of the plurality of candidate resources occurs within a physical sidelink feedback channel, PSFCH, transmission occasion;
receiving sidelink control information, SCI, from at least one second apparatus indicating a reserved resource for transmission of data by the at least one second apparatus;
determining, based at least on the reserved resource, at least one associated PSFCH resource for transmission of feedback to the at least one second apparatus; and
determining whether to exclude at least one candidate resource from the candidate resource set based at least on whether the at least one candidate resource overlaps, at least partially, with the at least one associated PSFCH resource.
